(19) United States
(12) Patent Application Publication
(10) Pub. No.: US 2005/0023720 A1
(43) Pub. Date: Feb. 3, 2005

(54) Method and apparatus for producing film from dope

(75) Inventor: Takashi Takeuchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 10/895,935

(22) Filed: Jul. 22, 2004

(30) Foreign Application Priority Data
Jul. 28, 2003 (JP) 2003-281354

(51) Int. Cl. B29C 39/14

(52) U.S. Cl. 264/216; 264/234; 264/237; 425/223; 425/447

(57) ABSTRACT

In a casting apparatus, a dope is cast on a cyclically moving belt to form a casting film, which is dried in a drying section. In the drying section, air shielding plates are provided to divide the casting film into a middle area and side edge areas in a widthwise direction. A hot air circulator has an air inlet and an air outlet, between which the hot air is cyclically fed. A cool air blower is provided so as to blow a cool air into side edge areas through an air outlet. Thus the increase of the temperature of the side edge portions of the casting film is prevented so as to make the temperature distribution of the casting film in a widthwise direction uniform, and therefore the generation of the bubbles is prevented.

### BACKGROUND OF THE INVENTION

1. Field of the Invention

The present invention relates to a method and an apparatus for producing a film for optical use from a dope.

2. Description Related to the Prior Art

In a method for producing a film from a dope, there is a solution casting method, in which the film can be produced more excellent in an optical isotropy and thickness uniformity than in a melt-extrusion method. Further, as a filtration can be made with use of a filter having small pore diameter, the foreign materials are not mixed in the dope to be cast. Accordingly, the produced film are used as the film for optical use, such as the films for an LCD, an organic EL, a polarizing filter, a photosensitive material, and the like.

In this method, after the polymer material is dissolved in a solvent to prepare a dope, the dope is cast from a casting die on a rotating metallic substrate, such as a belt or a drum, so as to form a casting film. Then a hot air is blown onto the casting film to dry it. When having a self supporting property, the casting film is peeled as a film from the substrate.

However, the metallic substrate is wider than the casting film, and when the hot air is blown onto the casting film cast on the metallic substrate, then not only the casting film but also the metallic substrate is heated. Accordingly, the casting film has a higher temperature in side edge portions than a middle portion, and thus the temperature distribution becomes large in the widthwise direction.

Further, when the hot air having a necessary conditions for providing the self supporting property in the middle portion of the casting film is blown, then the temperature of the side edge portions of the casting film becomes too high, and solvent in the casting film cause to generate bubbles. When the casting film having the bubbles is peeled, part of the casting film remains on the substrate. When the remaining part of the casting film is not removed thereafter, the amount of the remaining part becomes larger, and the casting becomes harder.

The phenomena of generation of the bubble occurs more easily when the temperature of the hot air becomes higher or the content of the solvent in the dope becomes higher. Further, when the temperature difference becomes larger between the side edge portions and the middle portion, the bubbles generates in the side edge portion more easily. Accordingly, when the temperature of the hot air to be blown is decreased, the demerits of generation of the bubbles become smaller. However, in this case, the middle portion of the casting film is dried for longer period to have the self-supporting property, and the casting speed becomes lower. Therefore the productivity becomes lower. Further, the content of the dope may be changed so as to avoid the demerits. In this case, although the generation of the bubbles is reduced, the optical functions become lower.

Accordingly, the Japanese Patent Laid-Open Publication No. S61-110520 teaches a method of producing the film, in which air shielding plates are provided above the side edges of the casting film such that the hot air is not blown to the metallic substrate, and thus the generation of the bubbles in the side edge portion is avoided.

However, positions of the air shielding plates are not enough considered in the method of the above publication. Therefore, when the air shielding plates are disposed near the side edges, or when a spaces between the each air shielding plate and the casting film is large, the hot air passes out through the space into outer side to heats the metallic substrate.

Further, in recent years, the higher production speed and the thinner film are demanded in the market. In order to realize the higher production speed, it is necessary that the temperature of the hot air to the casting film on the substrate becomes higher. Accordingly, the temperature of the side edges becomes higher, and the bubbles are generated more easily. Further, when the thickness of the film becomes smaller, the temperature of the substrate more influences on the conditions of the film. Accordingly, the improvement of the method in the above description is necessary.

### SUMMARY OF THE INVENTION

An object of the present invention is to provide a method and an apparatus for producing a film from a dope, in which bubbles don't generate in side edge portions of a casting film formed by casting the dope on a substrate.

In order to achieve the object and the other objects, in a method of producing a film from a dope in the present invention, air shielding members are provided so as to section a casting film on a substrate into a middle area and side edge areas in a widthwise direction. A heat air is blown to the middle area so as to dry the casting film uniformly in the widthwise direction. A cool air is blown to the side edge area from an inner to an outer side of the casting film on the substrate, such that a temperature distribution may be uniform in the widthwise direction of the casting film.

Further, in a preferable embodiment of a method of the present invention, a cool air is blown from an inner to an outer side of the casting film on the substrate, such that a temperature distribution may be uniform in the widthwise direction of the casting film.

The air shielding members are disposed in parallel in the range of 20 mm to 100 mm, preferably 20 mm to 80 mm inside from edges of the casting film and a space between the each air shielding member and the casting film is from 5 mm to 30 mm, preferably 5 mm to 15 mm.

The blowing of the cold air is performed with use of an air duct, and an outlet of the air duct is disposed in the range of 20 mm to 100 mm inside from the edges of the casting film. A space between the outlet and the casting film is in the range of 5 mm to 30 mm. The cool air is blown to the casting film at a blowing angle thereto in the range of 45° to 90°, preferably 60° to 80°. Further, the dew point of the cool air is at most −2° C., a temperature is in the range of 15° C. to 60° C., and a blowing velocity is in the range of 1 m/sec to 1 m/sec.

A content of the solvent in the casting film is in the range of 30% to 85% in percentage on wet weight basis. In this case, it is preferable to make the temperature distribution uniform in the widthwise direction. Further, a moving speed of the substrate is preferably in the range of 45 m/min to 100 m/min. further, the film is a cellulose ester film, and a thickness of the casting film on the substrate is in the range of 100 μm to 750 μm, preferably 100 μm to 300 μm, and a width is preferably in the range of 800 mm to 2200 mm.

An apparatus for producing a film from a dope of the present invention includes an air blowing device for blowing a heat air to a middle portion in a widthwise direction of a casting film on the substrate, and air shielding members provided so as to section the casting film into side edge areas and a middle area including the middle portion. The air shielding members shields the heat air blowing to outer sides in the widthwise direction. Further, a cool air is blown to the side edge areas from an inner to an outer side in the widthwise direction of the casting film on the substrate.

In a preferable embodiment of an apparatus of the present invention, a cool air blowing device is provided for blowing a cool air from an inner to an outer side of the casting film on the substrate in the widthwise direction.

According to the method and the apparatus for producing the film from the dope, the blowing of the hot air to the side edge portions of the casting film is regulated by the air shielding members. Therefore the temperature distribution in the widthwise direction of the casting film becomes uniform, such that the generation of bubbles in the side edge portions is prevented. Further, the side edge portions are cooled with the cool air blowing device. Accordingly the temperature distribution in the widthwise direction of the casting film becomes uniform, such that the generation of bubbles in the side edge portions is prevented.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production line;

FIG. 2 is a perspective view of a solution casting apparatus;

FIG. 3 is a sectional view of a drying section;

FIGS. 4A-4E are sectional views of the drying section, in which positions of air shielding plates are changed;

FIG. 5 is a table of results of difference of conditions, situations of bubbles, and results of discriminations of remaining casting film.

### PREFERRED EMBODIMENTS OF THE INVENTION

Polymers as raw materials used in the present invention are not restricted especially and may be used in a solution casting method. The preferable polymer is cellulose esters which are used for optoelectronics use, such as for producing a protective film for a polarizing filter and the like, and the especially preferable one is cellulose triacetate.

In the present invention, the film can be produced from a dope in which already known solvent is used. Single one or a mixture of halogenated hydrocarbon (such as methylenechloride and the like), alcohols (such as methanol and the like), esters, ethers and the like can be used as the solvent, when cellulose triacetate is used as the polymer for producing the film. The content of the solvent may be adequately adjusted, and the present invention is not restricted in the content. However, it is preferably in the range of 30 wt. % to 85 wt. % on the basis of wet weight.

Usually, the dope after the dissolution is filtrated to remove foreign materials or undissolved materials. As materials of the filters, there are known filter materials, such as filter paper, filter cloth, non-woven cloth, metal mesh, sintered metal filter, porous plate, and the like. The filtration removes the foreign materials and undissolved materials, such that the produced film may hardly or never have the descent of the quality, the damage or the defects to the products.

Further, the dope after the dissolution may be heated to make the dissolubility higher. In order to heat the dope, there are a method for heating with stirring the dope in a tank stationary disposed, a method for heating with feeding the dope with use of several sorts of heat exchangers, such as a multi pipe type or a jacket pipe with static mixers. Further, after the heating process, a cooling process may be provided. In the heating process, the inner pressure is made higher such that the temperature of the dope may be made higher than a boiling point under the atmosphere pressure. Thus in the heating process, the undissolved micro particles are dissolved perfectly or to have a small size which can be ignored for the practical use. Thus the number of the foreign particles is reduced to filtrate with a lower filtration pressure.

Already know additives may be added to the dope of the present invention. As the additives, there are UV-absorbing agents, dispersion agents, plasticizers, matting agents and the like. However the additives are not restricted in them. Further, to the dope may be added other additives, for example, silica, kaolin, talc, methylene chloride, methanol and the like. These additives may be added simultaneously in the preparation of the dope, or after the preparation to make an inline mixing into the fed dope with use of the static mixer.

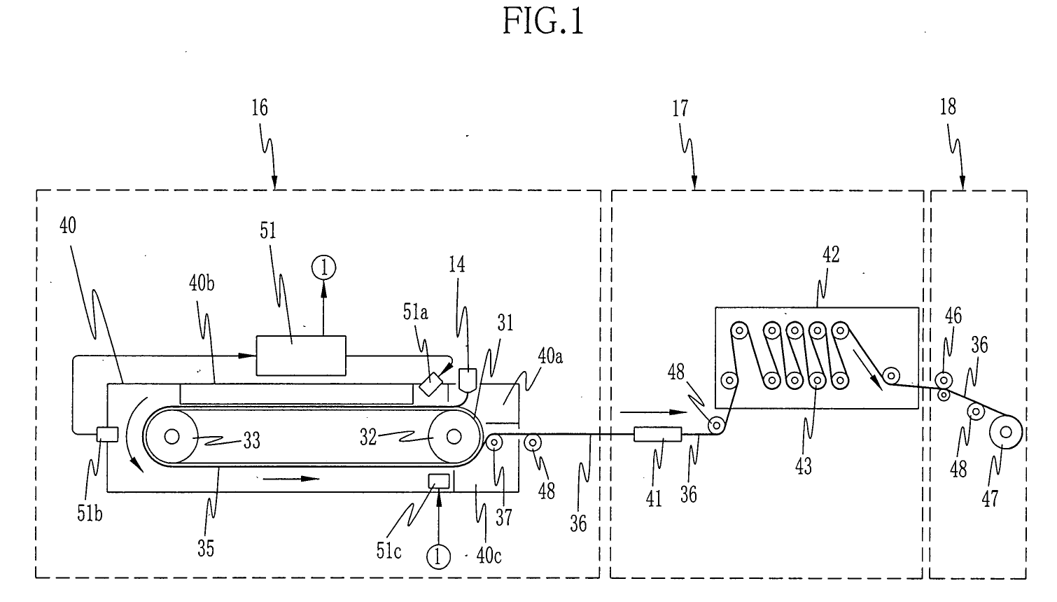

FIG. 1 illustrates the film production line to which the present invention is applied. The dope prepared as described above is cast to form the film. The film production line is substantially constructed of a casting apparatus 16, a drying apparatus 17 and a winding apparatus 18. Note that a dope preparation apparatus may be provided before the casting apparatus so as to prepare for the dope in the film production line.

The casting apparatus 16 is provided with a drying casing 40, a hot air circulator 51 and the like. The casing 40 includes a casting section 40a, a drying section 40b and a peeling section 40c. In the casting apparatus 16, whose detailed explanation is made below, a dope 12 is cast onto a belt 31 by a casting die 14 to form a long casting film 35. Then the air circulator 51 blows a hot air to the casting film 35 in the drying section 40b in the casing 40 to evaporate the solvent. Thus the casting film 35 is gradually dried to have the self-supporting property. Thereafter, the casting film 35 is peeled from the belt 31 by a peel roller 37 to produce a film 36.

According to the casting film 35 on the belt 31, the thickness, the width, and the casting speed are adequately changed. Preferably the thickness H, the width W, and the casting speed Vf satisfy the following conditions: 100 μm≦H≦750 μm, 800 mm≦W≦2200 mm, and 45 m/min≦Vf≦100 m/min. Especially the thickness H satisfies the condition 100 μm≦H≦300 μm. Note that in the present invention one sort of the dope is used to form the casting film of a single layer structure. However, the present invention is applied to embodiments in which a film of the multi-layer structure is formed.

The peel roller 37 may be a free roller or a drive roller. When the peel roller 37 is driven, it is preferably to control at least one of the draw ratio, a tension, and a slack. Note that the peel roller 37 has two effects to peel the film 36 and to guide to the drying apparatus 17. However, the peeling roller for peeling the film 36 and a guide roller (not shown) for guiding the film 36 to the drying apparatus 17 may be separately provided in the film production line.

The drying apparatus 17 is constructed of a tenter device 41 and a drying device 42. In the tenter device 41, the film 36 is dried while being drawn with applying the tension force to side edge portions. Thereafter, the film 36 is dried in the drying device 42 in which plural rollers are provided. After the drying, the film 36 is cooled to a room temperature while transported through a cooling chamber (not shown) provided in the drying device 42.

After the film 36 is dried enough, an edge cutter 46 cuts off the side edge portions of the film 36 such that the width of the film 36 may be a predetermined one. Thereafter the film 36 is wound by a winding device 47. Note that in the present invention, rollers 48 for transporting the film 36 are provided between apparatuses or devices, and the number thereof is not restricted. Note that the present invention does not depend on the construction of the above drying apparatus and winding apparatus, and the method of drying and winding. The present invention may be embodied in several known methods of drying and winding.

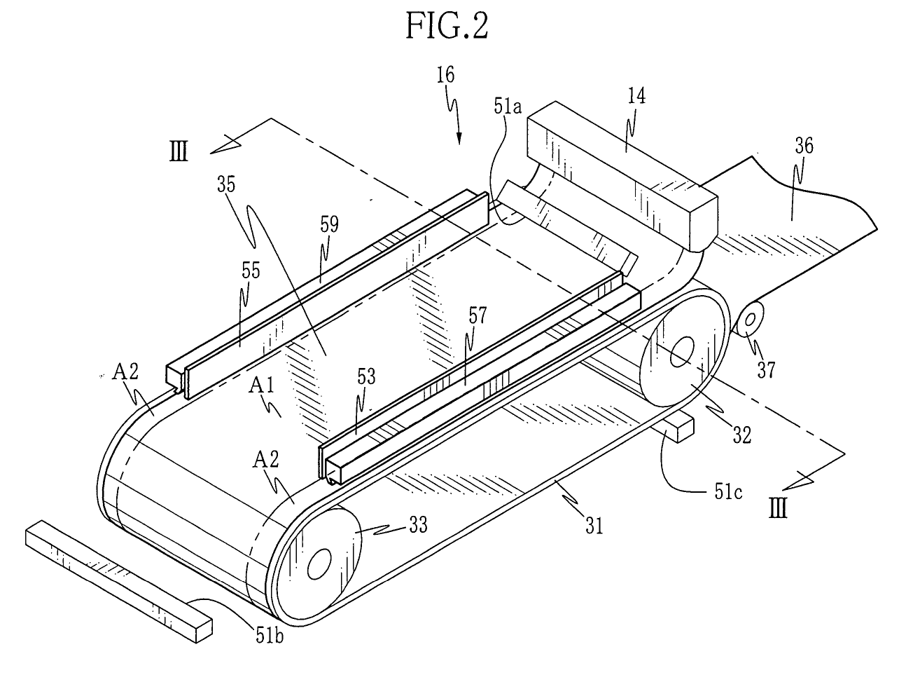

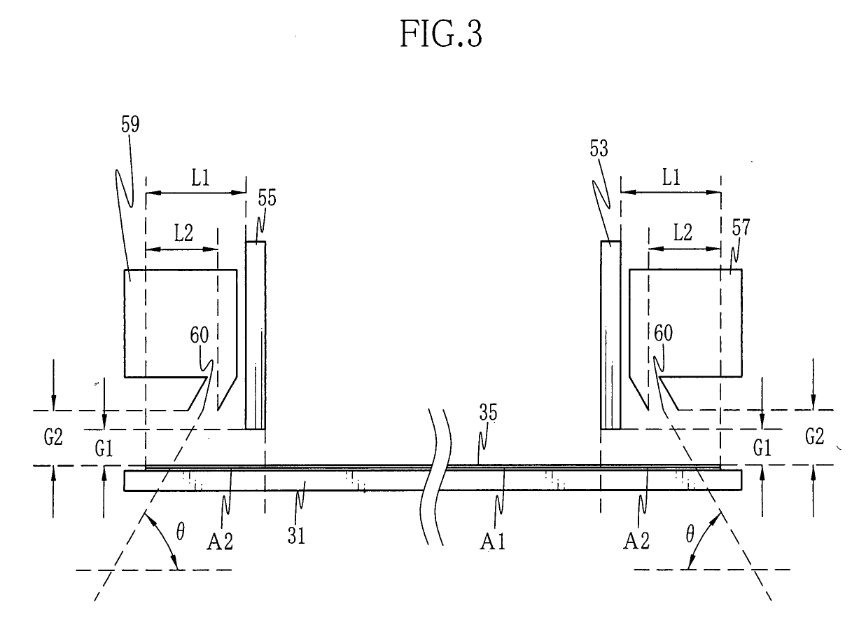

In the followings, the casting apparatus 16 of the present invention will be explained in detail with reference to FIGS. 2&3. FIG. 2 is a perspective view of the casting apparatus 16 from above. Note that FIG. 3 is a sectional view on a line a-a′ in FIG. 2.

The casting apparatus 16 includes the casting die 14, the belt 31 and the casing 40. The dope 12 is supplied to the casting die 14, and cast on the belt 31 as the substrate. The belt 31 is, for example, formed of stainless, and supported by two drums 32, 33 arranged horizontally. When the drums 32, 33 rotate, the belt 31 cyclically moves.

The dope 12 cast from the casting die 14 forms the casting film 35 on the belt 31, and is transported by moving the belt 31. The casing 40 is provided so as to cover the belt 31 and the casting film 35 along the moving path of the casting film 35. The casing 40 is partitioned to the casting section 40a in which the casting die 14 is disposed, the drying section 40b for drying the casting film 35 with rotation of the belt 31, and the peeling section 40c for peeing as the film 36 the casting film 35 which is provided with the self-supporting property by the drying. Note that other chambers (not shown) may be provided in upstream side in the moving direction of the belt 31 from the casting die 14 of the casting section 40a, so as to cast the dope 12 with uniformity onto the belt 31.

In the drying section 40b are provided air shielding plates 53, 55, an air outlet 51a and air inlet 51b of the air circulator 51 for circulating the air in the drying section 40b, and coolers 57, 59 for blowing a cool air toward the casting film. The air shielding plates 53, 55 are disposed at a position in an inner side from side edges of the casting film 35. The space above the casting film 35 is sectioned by the shielding plates 53, 55 into a middle area A1 and side areas A2. The air shielding plates 53, 55 extend into the moving direction.

The positions of the air shielding plates 53, 55 are not restricted especially. However, when they are shifted, a distance L1 from the side edge toward the center of the casting film 35 may satisfies the condition, preferably 20 mm≦L1≦100 mm, and especially 20 mm≦L1≦80 mm. When the distance L1 is less than 20 mm, the effect of shielding the hot air to the belt 31 is not changed but that to the casting film 35 becomes smaller. Accordingly the bubbles are easily generated. Further, the distance L1 is more than 100 mm, the drying speed of other part of the casting film 35 than the side edge portions becomes slower, which causes parts of the casting film 35 to remain on the belt 31 after the peeling.

Further, it is preferable that a gap G1 between the casting film 35 and each air shielding plate 53, 55 satisfies the condition, preferably 5 mm≦G1≦30 mm, and especially 5 mm≦G1≦15 mm. When the gap G1 is less than 5 mm, the air shielding plate 53, 55 often damages the belt 31. Further, when the gap G1 is more than 30 mm, a large amount of the hot air blown to a space between the air shielding plates 53, 55 escapes under them to the side edge areas A2, and the effect of shielding the air becomes lower. Further, the air shielding plates 53, 55 can be formed of optional materials. However, it is preferable to use SUS in consideration of influences, such as the rusting and the like, especially to use SUS316 or SUS316L.

The air outlet 51a is formed in the upstream side of the passage of the casting film 35 to blow the hot air to the middle area Al for drying the casting film 35. Otherwise, the air inlet 51b is formed in the downstream side of the passage of the casting film 35 to aspirate the air with solvent vapor generated by blowing the hot air. Further, below the belt 31 near the peeling section 40c is provided an air outlet 51c for blowing the hot air toward an air inlet 51b.

The air outlets 51a, 51c and the air inlet 51b are connected to the air circulator 51 (see, FIG. 1) which condenses for the recovery and the cleaning the solvent vapor in the atmosphere aspirated through the air inlet 51b. Then the air circulator 51 feed the hot air through the air outlets 51a, 51c toward the casting film 35. Since the hot air circulates through the drying section 40b, the solvent in the casting film 35 evaporates such that the casting film may have the self supporting property.

Each cooler 57, 59 is disposed in the side edge area A2 and has an air outlet 60 on lower surface disposed at a position inside the edge of the casting film 35. The coolers 57, 59 blow cooled airs through the air outlet 60 toward the side edge portion of the casting film 35 to cool the side edge portions of the casting film 35. Further, as the air shielding plates 53, 55 are disposed inside the air outlet 60, the cool air is blown toward the side edge portions of the casting film 35 and spreads for the outer side to cool the belt 31.

Further, the air outlet 60 is formed at a distance L2 from the side edge of the casting film 35 and at a gap F2 from the casting film 35. The distance L2 and the gap G2 satisfy the conditions, preferably 20 mm≦L2≦100 mm, 5 mm≦G2≦30 mm. Further, the cool air is blown in a direction at an angle θ to the casting film 35, and the angle θ satisfies the condition, preferably 45°≦θ≦90°, and especially 60°≦θ≦80°. A dew point, a temperature and a blowing velocity of the cool air fed by the coolers 57, 59 may be adequately changed. However, in order to cool the casting film 35 and the belt 31 effectively, the dew point DP, the temperature T and the blowing velocity Vc satisfy the following conditions, preferably DP≦−2° C., 15° C.≦T≦60° C., 1 m/sec≦Vc≦10 m/sec.

The operation of the present invention having the above structure will be explained in followings. In the casting apparatus 16, the dope 12 is cast onto the circularly moving belt 31 to form the casting film 35, which is transported to the drying section 40b. In the drying section 40b, the solvent is gradually evaporated such that the casting film 35 has the self-supporting property.

Thereby, the hot air is fed from the air circulator 51 to the middle area Al of the casting film 35. In the both outer sides of the air circulator 51, the air shielding plates 53, 55 are disposed, and therefore the hot air is not blown to the side edge areas A2 of the casting film 35. Further, the cool air is fed from the coolers 57, 59 toward the side edge areas A2 to cool the side edge areas A2 and the belt 31.

Thus the increase of the temperature is reduced in the side edge area A2 of the casting film 35, and the temperature distribution becomes constant in the widthwise direction of the casting film 35. Accordingly, the generation of the bubbles is prevented.

[Examination]

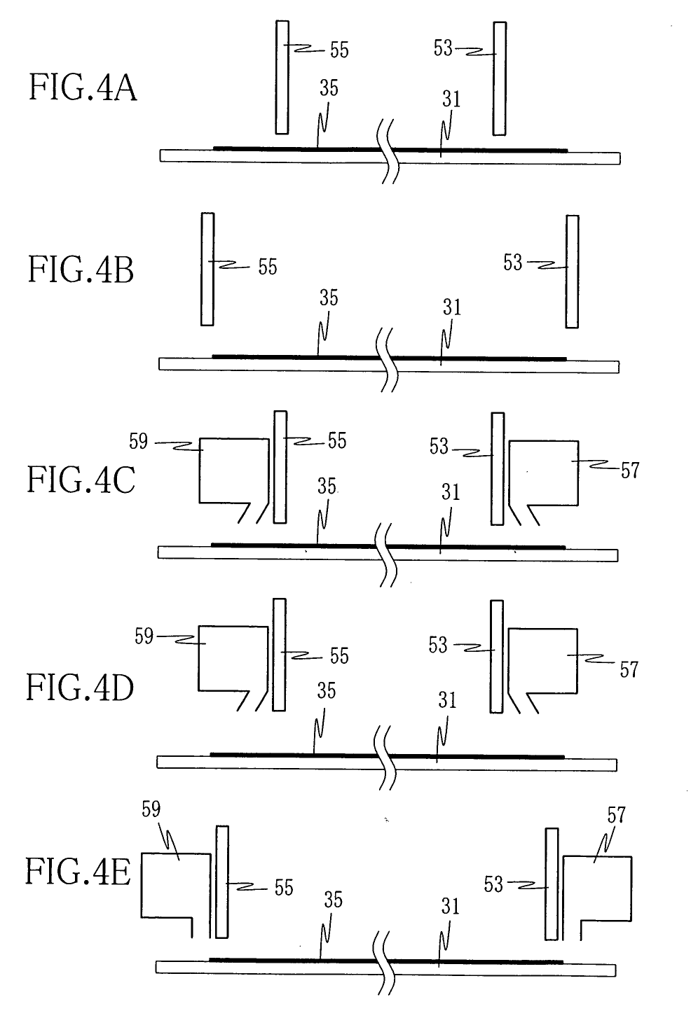

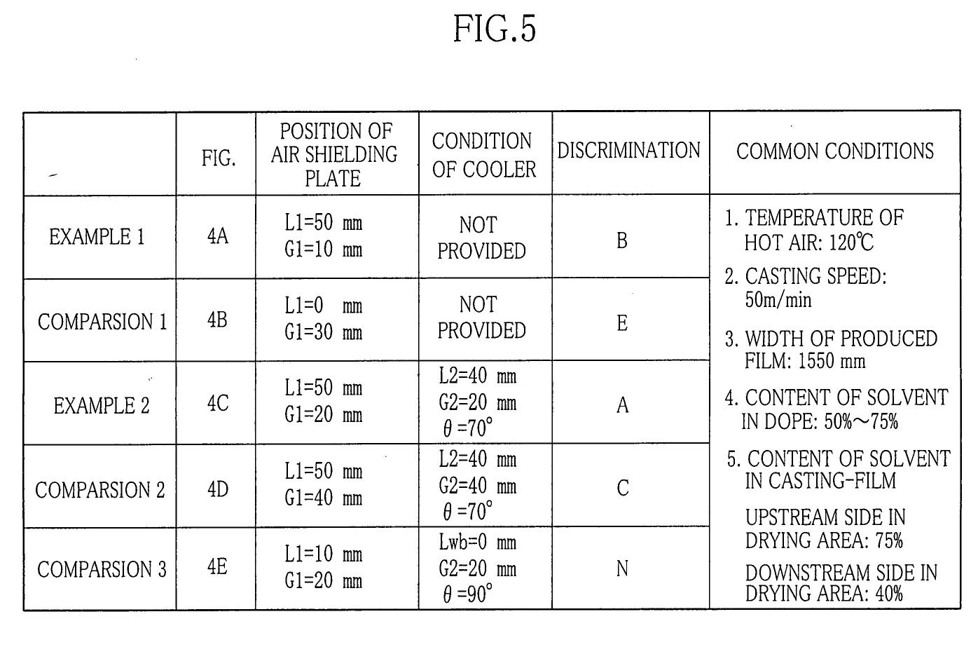

In the followings, Examples and Comparisons of Examination of the present invention are explained in reference with FIGS. 4&5. FIGS. 4A-4E are sectional vies of the drying section. FIG. 4A illustrates Example 1, FIG. 4B illustrates Comparison 1, FIG. 4C illustrates Example 2, FIG. 4D illustrates Comparison 2, and FIG. 4E illustrates Comparison 3. Among these Examples and Comparisons, the conditions of the drying sections were changes, and the situation of the generation of the bubbles in the side edge portion of the casting film and the remaining of the casting film on the substrate after the peeling were observed with eyes. The results thereof in Examination were illustrated a table in FIG. 5.

In this Examination, the hot air was fed at 120° C. by the air circulator, and the casting speed was 50 m/min. the width of the produced film was regulated to 1550 mm. Then the produced films in the Examination were compared. The content of the solvent in the dope was in the range of 50% to 75%. Thereby the content of the casting film was 75% in the upstream side in the drying section, and 40% in the downstream side in the drying section.

The situation of the generation of the bubbles was discriminated as follows: when the bubbles were not observed, the discrimination was A; when the bubbles were sometimes observed but the casting film did not remain on the belt, the discrimination was B; and when the bubbles were observed but the casting film remaining on the belt did not become larger, the discrimination was C; when the bubbles were often observed and the casting film remaining on the belt became larger, the discrimination was N; and when the bubbles were continuously generated and the casting film continuously remained on the belt, the discrimination was E. The results of the discrimination were also shown in FIG. 5.

### EXAMPLE 1

In Example 1, the drying section was provided with only the air shielding plates which were positioned in the conditions L1=50 mm and G1=10 mm. Then the casting was made, and the bubbles were observed in the side edge portions. However, the casting film did not remain on the belt. Therefore the discrimination was B.

[Comparison 1]

In Comparison 1, the drying section was provided with only the air shielding plates whose positioning conditions were changed from Example 1. In Comparison 1, the conditions were L1=0 mm and G1=30 mm. Then the casting was made, and the bubbles were continuously generated, which causes the continuous remaining of the casting film on the belt. Accordingly the discrimination was E.

### EXAMPLE 2

In Example 2, the drying section was provided with only the air shielding plates and the cooler. The positioning conditions of the air shielding plates were L1=50 mm and G1=20 mm, and those of the cooler were L2=40 mm, G2=20 mm, and θ=70°. Then the casting was made, and the bubbles were not observed to casting the dope in a good situation. Accordingly the discrimination was A.

[Comparison 2]

In Comparison 2, the drying section was provided with the air shielding plates and the cooler. The positioning conditions of the air shielding plates were L1=50 mm and G1=40 mm, and those of the cooler were L2=40 mm, G2=40 mm, and θ=70°. Then the casting was made, and the bubbles were observed in the side edge portions. Further, the generation of the bubbles caused the remaining of the casting film. However the remaining did not become larger. Accordingly the discrimination was C.

[Comparison 3]

In Comparison 3, as same as Comparison 2, the drying section was provided with the air shielding plates and the cooler, and their positioning conditions were changed from Example 2. In Comparison 3, the positioning conditions of the air shielding plates were L1=10 mm and G1=20 mm, and those of the cooler were L2=0 mm, G2=20 mm, and θ=90°. Then the casting was made, and the bubbles were observed in the side edge portions. Further, the generation of the bubbles caused the remaining casting film, and the remaining of the casting film became larger. Accordingly the discrimination was D.

Various changes and modifications are possible in the present invention and may be understood to be within the present invention.

1. A method of producing a film from a dope prepared by dissolving a polymer into a solvent, said dope being cast on a moving substrate to form a casting film, said casting film being dried and peeled as said film from said substrate, said method comprising steps of:
providing air shielding members so as to section said casting film into a middle area and side areas in a widthwise direction; and
blowing a heat air to said middle area toward said casting film.

2. A method as defined in claim 1, wherein a cool air is blown from an inner to an outer side in said widthwise direction of said casting film on said substrate.

3. A method of producing a film from a dope prepared by dissolving a polymer into a solvent, comprising steps of:
casting said dope on a moving substrate to form said casting film;
blowing a heat air to said casting film for the drying;
blowing a cool air in a widthwise direction of said casting film from an inner side to an outer side; and
peeling said casting film as said film from said substrate.

4. A method as defined in claim 2, wherein said air shielding members are disposed in the range of 20 mm to 100 mm inside from edges of said casting film, and a space between said each air shielding member and said casting film is from 5 mm to 30 mm.

5. A method as defined in claim 4, wherein said each air shielding member is disposed in the range of 20 mm to 80 mm inside from said edges of said casting film.

6. A method as defined in claim 5, wherein a gap between said each air shielding member and said casting film is in the range of 5 mm to 15 mm.

7. A method as defined in claim 6, wherein the blowing of said cold air is performed with use of an air duct, and an outlet of said air duct is disposed in the range of 20 mm to 100 mm inside from said edges of said casting film, and a gap between said outlet and said casting film is in the range of 5 mm to 30 mm, and said cool air is blown at a blowing angle to said casting film in the range of 45° to 90°.

8. A method as defined in claim 7, wherein said cool air is blown to said casting film at the blowing angle in the range of 60° to 80°.

9. A method as defined in claim 8, wherein said cool air has a dew point at most −2° C. and a temperature in the range of 15° C. to 60° C., and a blowing velocity of said cool air is in the range of 1 m/sec to 10 m/sec.

10. A method as defined in claim 9, wherein a content of said solvent in said casting film is in the range of 30% to 85% on wet weight basis.

11. A method as defined in claim 10, wherein a moving speed of said substrate is in the range of 45 m/min to 100 m/min.

12. A method as defined in claim 11, wherein said film is a cellulose ester film, a thickness of said casting film is in the range of 100 μm to 750μm, and a width is in the range of 800 mm to 2200 mm.

13. A method as defined in claim 12, wherein said thickness of said casting film is in the range of 100 μm to 300 μm.

14. An apparatus for producing a film from a dope prepared by dissolving a polymer into a solvent, said dope being cast on a moving substrate to form a casting film, said casting film being dried and peeled as said film from said substrate, said apparatus comprising:
a hot air blowing device for blowing said heat air to a middle portion in a widthwise direction of said casting film;
air shielding members for sectioning said casting film into side edge areas and a middle area including said middle portion, said air shielding member shielding said heat air blowing to outer sides in the widthwise direction.

15. An apparatus as defined in claim 14, wherein a cool air is blown to said side edge areas from an inner to an outer side in said widthwise direction of said casting film on said substrate.

16. An apparatus for producing a film from a dope prepared by dissolving a polymer into a solvent, said dope being cast on a moving substrate to form a casting film, said casting film being dried and peeled as said film from said substrate, said apparatus comprising:
a cool air blowing device for blowing a cool air from an inner to an outer side of said casting film in said widthwise direction.
